(19) United States
(12) Patent Application Publication
(10) Pub. No.: US 2017/0042379 A1
(43) Pub. Date: Feb. 16, 2017

(54) Searing Plates

(71) Applicant: Smith's Cooking Systems Pty Limited, Temora (AU)

(72) Inventor: John Smith, Temora (AU)

(21) Appl. No.: 15/225,831

(22) Filed: Aug. 2, 2016

(30) Foreign Application Priority Data
Aug. 12, 2015 (AU) 2015903219

(51) Int. Cl. A47J 37/10

(52) U.S. Cl. CPC A47J 37/108

(57) ABSTRACT

A searing plate rests on or is attachable to a grill. The plate has features that impart a graphic image to food being cooked.

### FIELD OF THE INVENTION

The invention relates to devices for the ornamental searing of meat, for example, in the context of a barbeque preparation of food.

### BACKGROUND OF THE INVENTION

Searing is a chemical reaction that occurs on the surface of foods, particularly meats, dumplings and breads. Searing on meat proceeds rapidly from around 140 to 165 C. Searing at higher temperature results in caramelisation and pyrolysis.

In accordance with the Applicant's previous Australian Patent Application No. 2014904988, searing may also be used as a way of ornamenting, marking or adding information content to a food surface.

The present application provides additional apparatus that can be used to perform searing for the purpose of adding ornament or information to a food surface, particularly a meat surface.

### OBJECTS AND SUMMARY

It is an object of the invention to provide devices for searing food to create graphic images.

### BRIEF DESCRIPTION OF THE DRAWING FIGURES

In order that the invention be better understood, reference is now made to the following drawing figures in which:

FIG. 1 is a cross sectional view of a manual searing device comprising a searing plate and handle.

FIG. 2 is perspective view of the device depicted in FIG. 1.

FIG. 3 is a cross sectional view of a searing plate and handle.

FIG. 4 is a perspective view of the searing device depicted in FIG. 3.

FIG. 5 illustrates two styles of searing plates.

FIG. 6 is a perspective view of a grill having bars on which are located four searing plates.

FIG. 7 is a side elevation of a searing plate affixed by clamping to the bars of a grill.

FIG. 8 is a side elevation of a searing plate affixed by clamping to the bars of a grill.

FIG. 9 is a side elevation of a searing plate affixed by clamping to the bars of a grill.

FIG. 10 is a side elevation of a searing plate that is affixed to grill bars using a resilient clip.

FIG. 11 is a side elevation of a searing plate that is affixed to grill bars using a resilient clip.

FIG. 12 is a side elevation of a searing plate affixed to the bars of a grill using a clamp and threaded fastener arrangement.

FIG. 13 is a side elevation of a searing plate affixed to the bars of a grill using a clamp and threaded fastener arrangement.

FIG. 14 is a side elevation of a searing ring retained on the bars of a grill using a resilient clip that is fastened to the searing plate.

FIG. 15 is a perspective view of a health grill having a solid grill plate onto which is affixed or formed a searing plate.

### BEST MODE AND OTHER EMBODIMENT OF THE INVENTION

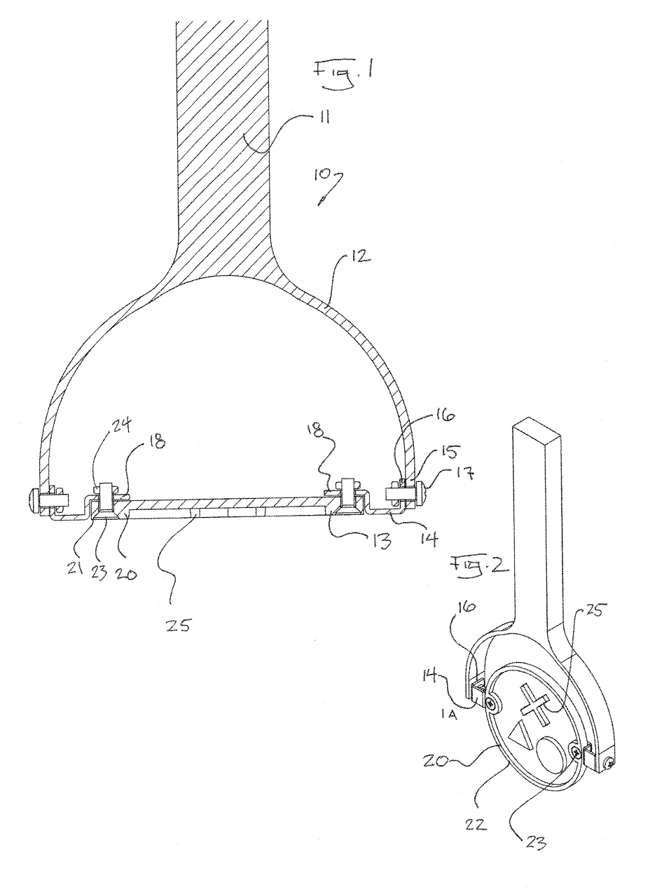

As shown in FIG. 1, a searing appliance 10 has a handle 11 connected to or forming a double ended yoke 12. The yoke supports a metal searing plate 13. In this example, the searing plate 20 is round but need not be round. Brackets 14 are used to attach the plate 13 to the terminal ends of the yoke 15. In the examples of FIGS. 1 and 2, it can be seen that the attachment bracket 14 has an end 16 having a through opening in it. A fastener 17 passes through an opening in the end of the yoke 15 and though the opening in the bracket 14. Accordingly, the bracket is able to pivot around the fastener 17 as suggested by FIG. 2. An opposite end of the bracket 14 forms a tang 18 in which is formed a second bracket opening. The plate 13 has a pair of countersunk through holes 21 located diametrically opposite each other near the plate's rim 22. A fastener 23 passes through the opening in the plate and the second opening of bracket and is retained by a nut 24.

In this way, the plate can be placed face down on a barbeque grill or other heated surface and brought to searing temperature. The pivoting action of the fastening arrangement allows the plate to be manipulated in a number of different orientations. Any number of different fastening arrangements can be used to permanently or temporarily attach the plate 20 to the handle 11. The searing plate 20 may be solid or perforated in the examples of FIGS. 1-4 the plate is essentially solid having raised searing image features 25.

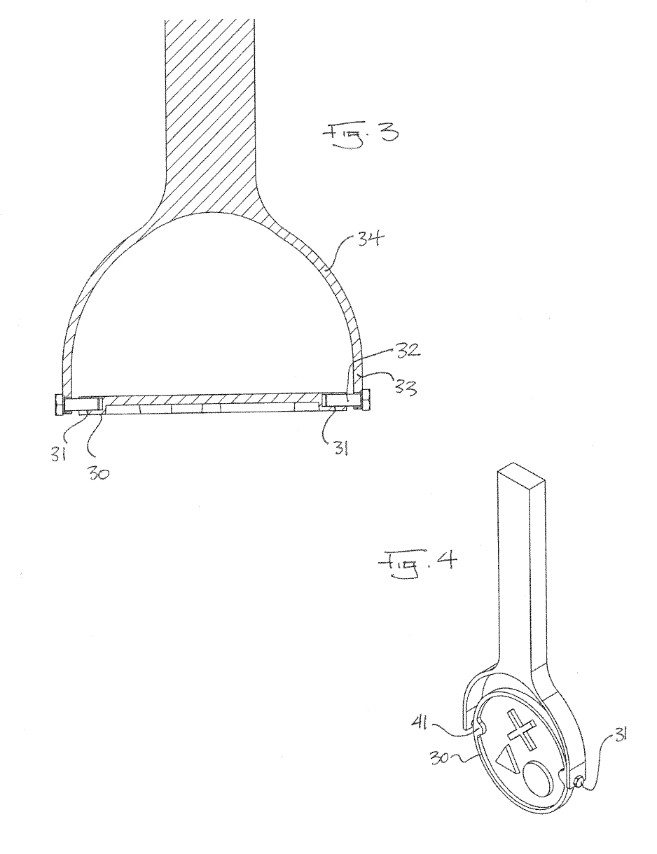

In the examples of FIGS. 3 and 4, no bracket 14 is required. Instead, the searing plate 30 has two blind bores 31 form diametrically opposite each other. Each bore receives a pin 32 that is retained by one end 33 of the yoke 34. The pin 32 may be integrally formed with the yoke or pass through an opening in the yoke. As suggested by FIG. 4, the searing plate 30 can rotate about the pins 31. In the example of FIG. 4, the area around the blind bore 31 is provided with additional surrounding material 41, the better with which to receive the bore opening.

As suggested by FIG. 5, a searing plate 50 may be attached to a handle or yoke in a number of ways including, but not limited to a pair of transverse blind bores 51 or through openings 52. In addition, the imprint or image made by the searing plate may be made by raised features 53 that project above a floor 54 of the searing ring, or by through openings 55 in the searing ring.

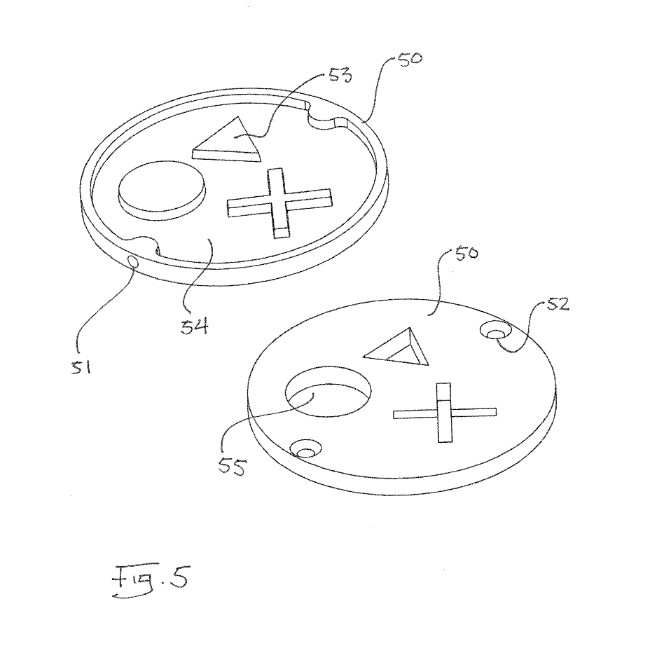

As shown in FIG. 6, a searing ring 60 may be placed directly on the upper surface of a grill such as a barbeque grill 61. However, to facilitate its use and to improve heat transfer between the searing ring and the grill 61, the searing ring 60 may be temporarily or permanently affixed to the grill 61. For example, in the examples of FIGS. 7-14, a searing plate that imparts a graphic image 70 can be temporarily, semi-permanently or permanently affixed to the bars of a grill 71 in a number of convenient ways.

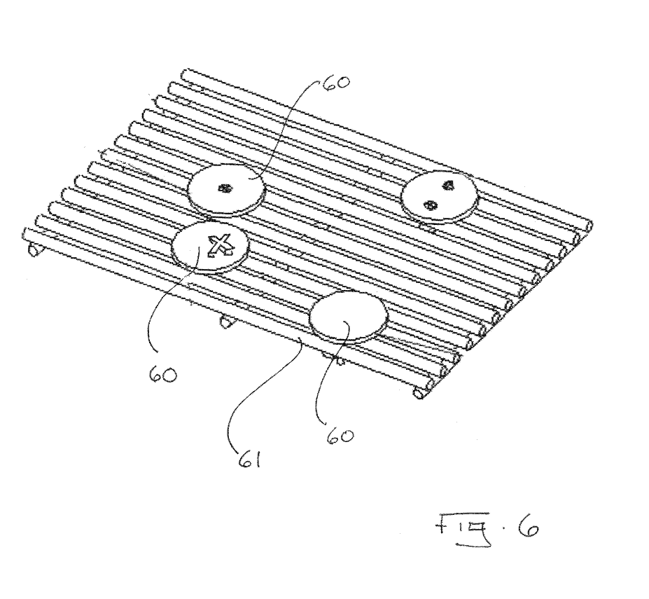

As shown in FIG. 7, the searing plate 70 may be clamped on to the bars 71. In this example, two fixing rods 72 extend from a rear surface 73 of the plate 70. An extension rod 72 may be afformed integrally with the plate 70, screwed into it, or provided by way of a fastener bracket such as a countersunk fastener 74 that extends through the plate 70 and through the bars of the grill 71. The fixing rods 72 act as guides for a clamping plate 75 having through openings 76 for each of the rods 72. A threaded nut 77 cooperates with threads on each rod 72 to urge the backing plate 75 into a clamping arrangement with the plate 70 that traps the bars 71 between the plates 70 and the backing plate 75. The threaded fastener 77 may be spaced away from the backing plate 75 by a tube 78 that fits over the rod 72. The tube 78 may be provided in two separate portions with a locking washer 79 between the tubular portions that fit over a central rod or fastener. A similar arrangement is depicted in FIG. 8, wherein one or more separate backing plates 81 are provided, one backing plate 81 being used to clamp one grill bar 71. As shown in FIG. 9, one backing plate 91 may be associated with two or more grill bars 71, a single rod 92 being used to guide and retain the backing plate 91.

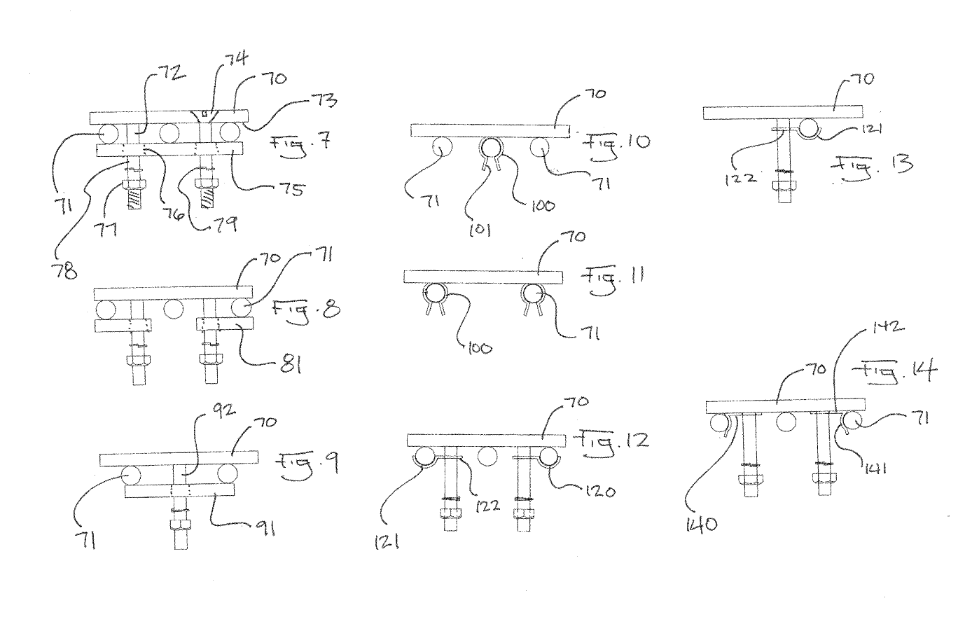

In the examples of FIGS. 10-14, resilient clips 100 are affixed to or associated with the searing plate 70 and are used to directly attach the searing plate 70 to one or more bars 71. In the example of FIG. 10, the clip 100 is essentially “C” shaped, having diverging pilot extensions or ears 101 to promote expanding the clip over a bar 71 when clips 100 are used, the grill bars 71 need not be removed in order to install the searing plate 70. In the example of FIG. 11, two or more resilient clips 100 are used to affix the plate 70 to the bars 71.

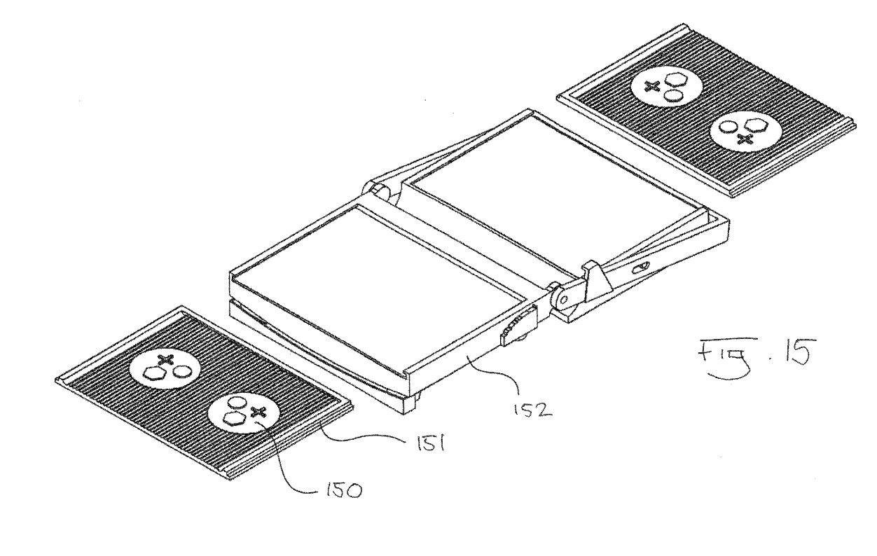

In FIGS. 12 and 13, clips 120 are used but they are not necessarily resilient. In the example of FIGS. 12 and 13, each clip comprises a curved bar engaging portion 121 and a tab portion 122. The tab portion is affixed to the searing ring 70 by a fastener weld or threaded arrangement (see FIGS. 7-9). In the example of FIG. 14, a resilient or non-resilient clip 140 has a curved portion 141 that secures a bar 71 by engaging it laterally and also has a flat extension 142 that is either permanently affixed to an underside of a searing ring 70 or affixed using a threaded fastener such as a bolt or an extended threaded rod of the type suggested by FIGS. 7-9.

As shown in FIG. 15, a searing plate 150 may be placed on to, affixed to, integrated into or otherwise used in conjunction with a solid grill plate 151. Solid, essentially unperforated grill plates are known to be used with a variety of domestic and professional kitchen appliances such as so-health grills 152. The grill plates 151 may be permanently attached to the grill 152 or may be removable in any one of a number of ways that are commonly known in the art. Searing plates 150 of any shape may be permanently cast into the grill plates 151 or affixed in any of the methods suggested above including fasteners, rivets, weldments, clips, friction or clamping plates.

Although the invention has been described with reference to specific examples, it will be appreciated by those skilled in the art that the invention may be embodied in many other forms.

As used herein, unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” or “example” means that a particular feature, structure or characteristic described in connection with the embodiment is included in at least one embodiment of the present invention. Thus, appearances of the phrases “in one embodiment” or “in an example” in various places throughout this specification are not necessarily all referring to the same embodiment or example, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Any claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Thus, while there has been described what are believed to be the preferred embodiments of the invention, those skilled in the art will recognize that other and further modifications may be made thereto without departing from the scope of the invention, and it is intended to claim all such changes and modifications as fall within the scope of the invention.

While the present invention has been disclosed with reference to particular details of construction, these should be understood as having been provided by way of example and not as limitations to the scope of the invention.

What is claimed is:

1. A searing plate device for use with a grill surface comprising:
a plate adapted to rest on a grill;
the plate having on a front surface, raised features that project above a floor of the plate;
the features imparting a graphic image to food being cooked on the plate.

2. The device of claim 1, further comprising:
a means of affixing the plate to the grill, the means located on a rear surface of the plate.

3. The device of claim 2, wherein:
the means comprises one or more rods that extend from the rear surface.

4. The device of claim 3, further comprising:
a clamping plate having a trough opening for each rod.

5. The device of claim 4, further comprising:
a threaded nut for each rod,
the rods being threaded to retain the nut and so the clamping plate.

6. The device of claim 2, wherein:
the means is a clamp.

7. The device of claim 2, wherein:
the means is one or more resilient clips.

8. The device of claim 7, wherein:
at least one clip is “C” shaped clip has diverging pilot extensions.

9. The device of claim 8, wherein:
the “C” shaped clip has diverging pilot extensions.

10. The device of claim 1, further comprising:
a double ended yoke that cooperates with the plate;
the yoke having terminal ends that attach to the plate.

11. The device of claim 10, further comprising:
a handle attached to the yoke.

13. The device of claim 1, wherein:
the searing plate is sound.

14. The device of claim 2, wherein:
the searing plate is sound.

15. A solid or perforated grill plate for cooking food on an appliance, wherein:
a searing plate is permanently attached or cast into the grill plate; the searing plate having raised features on a front surface that impart a graphic image to food being cooked on the grill plate.
